(19) United States
(12) Patent Application Publication
(10) Pub. No.: US 2009/0024064 A1
(43) Pub. Date: Jan. 22, 2009

(54) Plasticized Article for Treating the Skin

(76) Inventors: Patrice Sant' Ana Caceres, Valinhos (BR); Joao da Silva, Valinhos (BR)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/794,018

(22) PCT Filed: Nov. 7, 2005
(86) PCT No.: PCT/EP05/11974

§ 371 Date: Feb. 25, 2008

(30) Foreign Application Priority Data
Dec. 22, 2004 (BR) 0405989-1

(51) Int. Cl. A61H 7/00

(52) U.S. Cl. 601/137

(57) ABSTRACT

The present invention refers to a plasticized article for treating the skin, particularly a massaging personal cleansing bar that provides users with practicality, durability and comfort, with its shape of specific dimensions and proportions capable of increasing the soap's useful life, prolonging the massaging effect consisting of projections.

The present invention refers to a plasticized article for treating the skin comprising a grip body having projections, wherein the weight of the projections in relation to the total weight of the article provides various beneficial effects to the user, mainly cleansing and massaging of the skin, durability and resistance to breakage.

The object of the invention in its more particular embodiments is a cleansing bar comprising surfactants or synthetic detergents (also known as “syndets”), soap (typically a salt or mixture of fatty acid salts), or a mixture of both. The article is especially suitable for treating the skin with respect to cleansing, massaging or both at the same time.

The article has ergonomic characteristics that promote proper holding by a user, and a pleasant massaging effect when used on the skin. In addition, its dimensions and proportions favor greater resistance, stability and durability in relation to existing similar articles. In specific embodiments, it eliminates or limits water accumulation on its surfaces, preventing softening and early wear of the article.

Modern consumers are more and more receptive to articles intended for treating the skin in various ways, for example those capable of promoting skin cleansing or enabling massaging, or both, and even other additional benefits, when favoring new sensorial experiences, showing novelty or some form of pleasant feelings during treatment, which can be used during bathing or showering. For example, cleansing bars that moisturize, exfoliate, massage and tone the skin have been well accepted by consumers.

With the advent of specialty soaps and the advancement of personal care market, evidenced by the emergence of personal care boutiques, personal cleansing soaps with complex shapes and structures are now sold. Examples of these are the so-called massage soaps, which have projections of various shapes on their surfaces. A second example is a bar with an image in high relief that attracts attention, such as for example a comic's personages, which is especially suitable for kids, and encourages personal hygiene.

Well-known soaps having protrusions or projections, such as those with the purpose of cleansing and with projections on at least one of its sides, are all practically made by hand, for example by individual manual stamping, or by sculpture. For this reason, they target a market with limited distribution and high sales price. It would be desirable, due to the attraction created by this kind of product, to offer them to a wider range of consumers.

Therefore, the present invention refers to a new concept of an article for treating the skin, mainly a personal care massaging bar, considering that its specific characteristics relating to weight of the projections with the total weight of the article promote a longer-lasting massaging effect, with additional benefits of ergonomics, resistance and increased service life of the soap.

According to the meaning herein, the skincare article is one suitable for personal care (including cleansing and/or personal hygiene) without excluding other benefits, such as massaging, moisturizing, softening, etc. in the form of bars, blocks or weights, for example, containing artificial detergents or surfactants (generically referred to as syndet bars), soaps, mixtures of both or with other compounds suitable for hygiene, cleansing or personal care. Also according to the meaning herein, a plasticized article for treating the skin refers to the fact that it comprises a plasticizing agent that makes it less prone to breakage during use or due to improper use, reducing brittleness, toughness and coarseness on contact with user's skin.

By their turn, groups of consumers consulted on skincare articles, especially massaging cleansing bars provided with projections, indicated a clear perception of effective massage on contact with skin during use when certain ratios of weight of the projections to the total weight of the bar were used. Such perceptions also allowed other technical and sensorial characteristics to be appointed for the article's use, which was considered an effective massaging product intended for skin toning, a first step and a pleasanter manner of caring for skin tone.

Cleansing bars, mainly soap bars, which consist of a surface having projections meant to give a massaging effect, are known and sold in the market. However, all of them have inconveniences for the user, such as low resistance to breaking of projections, quick wear, not very adequate ergonomics, and limited massaging effect. It has now been discovered that these inconveniences are reduced by utilizing the correct ratio of the weight of projections to the total weight of the article.

Such projections usually have a cylindrical or half-spherical shape of low height, and thus the massaging effect of soap bars from prior art is reduced. That is, the projections are quickly used up in relation to the rest of the article when one uses the cleansing bar during bath or shower, and the shape of the bar becomes conventional, loosing its massaging effect. As a result, users end up having a low cost-benefit ratio on purchasing these articles, as they would be paying the price for a massage soap that quickly, after little use, becomes a substantially smooth, conventional soap without projections.

In other alternatives of prior art, the projections are too long or too far from the base, breaking easily and/or the base is used up in little time, impairing or preventing its use, whether as a hygiene article or as a massaging article.

An example of the type of massage soap is the one shown in Brazilian utility model patent application: MU 7000443-9, and in Brazilian industrial design registration: DI 6304413-7. In these documents, the shape and mainly the height of the projections end up impairing the massaging effect during the service life of the cleansing bars, since the projections are used up before and faster than the rest of the soap, turning the bar shape into that of a conventional soap, quickly and practically eliminating the massaging effect.

Another example of a cleansing bar having a massaging surface is that from: U.S. Pat. No. 5,834,410, which refers to a soap with a surface having several projections or ridges. Specifically, the height of the projections represents more than 50% of the soap's total thickness, which ends up creating two inconveniences: i) weakens the projections, as eventual falling of the soap on the floor can impair the massaging part; and ii) on using the soap, the grip portion can be used up before said projections, making its use impossible.

Thus, one note that massage soaps currently known and used have various use inconveniences and limitations, without any concern with the ratios of the base to the projections, a fact that ends up disappointing users with respect to durability, efficiency and ergonomic comfort.

The purpose of the present invention is to provide an article, specifically a massaging, cleansing bar, that solves or substantially limits prior art inconveniences found.

More specifically, the present invention refers to a plasticized article for treating the skin—typically a massaging cleansing bar—comprising a surfactant agent as means of cleansing, and a plasticizing agent having a grip body with an outer and inner surface, characterized in that the inner surface comprises one or more projections, wherein the weight of the projections is between about 28% and about 70% of the article's total weight. The article of the invention thus provides a pleasant and effective massage, in addition to promoting resistance, stability and durability. Particularly, the weight of the projections conveniently varies between about 28% and about 50% of article's total weight, more particularly the weight of the projections is about 28% of the total weight of the article of the present invention.

In a particular alternative embodiment of the invention, the weight of each individual projection is about 1.5% to about 4.0% of the article's total weight.

In another specific embodiment of the invention, the total number of projections varies between 1 and 50, particularly between 10 and 20, more particularly this number is 13.

In another specific alternative embodiment of the invention, the inner surface of invention article's grip body comprises of at least some projections with substantially elliptical cross-section, wherein the total area of the top of the projections, optionally plane, corresponds to about 20% of the inner surface area of the grip body (according to the meaning herein, “inner surface area of the grip body” means the sum of the surface area occupied by the projections with the surface area not occupied by the projections when viewing the projections from above).

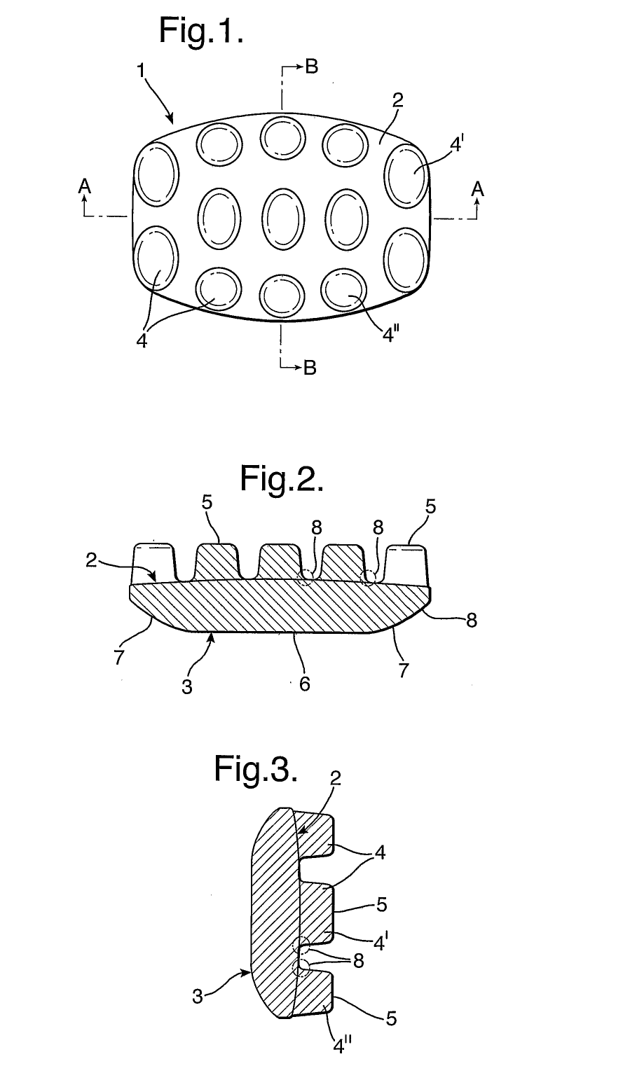

In other words, the inner surface area is the total visible area from a plan view, as in attached FIG. 1. In this alternative, some projections have substantially circular cross-section, and others substantially elliptical cross-section; advantageously the projections located nearer the center have elliptical cross-section.

In a particular embodiment of the invention, each projection weighs about 1.66 grams to about 2.5 grams.

Slightly round edges of the invention article's projection's ends, in relation to the presence of sharp angles, eliminates or reduces eventual feelings of discomfort on the user's skin during use.

Specifically, the perimeter or line delimiting the cross-section area of the projections is preferably substantially free of sharp angles and points; the typical shapes have circular or elliptical cross-sections.

In a particular embodiment of the invention, the projections have an average diameter and height ratio that positively influences resistance and durability during article's use, i.e. between about 1:1 and about 3:1. For elliptical cross-section projections, the average diameter refers to the average of the sum of greater axis and smaller axis dimensions.

The weight of invention's cleansing article is usually between about 70 grams and about 350 grams, more particularly about 95 grams.

In another particular aspect of the invention, the walls of the projection located on the cleansing article's edges form an angle directed toward the central area of the article by about 5°, thus promoting a greater stability, i.e. adapting the article to a stable rest position when supported on the projections.

In another particular aspect of the invention, the cleansing article's projections are cut cones (e.g. truncated cones or frustum cones) from their bases to the ends.

In another aspect of the present invention, there is provided a massaging soap bar whose shape minimizes water accumulation on the surfaces, reducing the risks of degradation and early wear of the grip portion, as well as of the massaging part. In other words, the region where the lateral walls of the projections meet with the inner surface of the grip body is substantially free of sharp angles, the region being (optionally) substantially round.

In another particular embodiment of the invention, the ratio between the projection's height (i.e., its elevation in relation to the inner surface of the grip body) to the total thickness of the cleansing article is between about 40% and about 50%. In a specific aspect of the invention, the projections height is between about 5 mm and about 20 mm, particularly between about 5 mm and 16 mm, and more particularly between 11.5 mm and 13.5 mm.

A specific design of invention article's grip body is its smooth outer surface, curved downwards (downwards herein means toward the opposite inner surface) and outwards, from a generically rectangular and plane central area.

From a wider perspective, the invention refers to a plasticized article for cosmetically treating the skin, where the term “treating” includes cleansing and massaging, consisting of projections of about 28% to about 70% of article's total weight, having an ergonomic shape that makes its handling easy and pleasant to users, with an optimized ratio of the wear of the grip portion to that of the massaging portion, prolonging the massaging effect and feeling during its use, without causing early wear of any of its portions.

The objectives, effects and advantages of the plasticized article for treating the skin, and objects of the present invention, will become clear to those skilled in the art, considering the detailed description below given herein under the form of particular embodiments of the massaging soap bar. For ease of illustration the invention is described by way of example only, with reference to the attached schematic drawings, without imposing any restrictions on invention's scope, apart from those contained in the attached claims, in which:

FIG. 1 is a plan view of a massaging surface of the soap bar, according to a particular embodiment of the present invention;

FIG. 2 is a cross-section view of the soap bar according to lines A-A indicated in FIG. 1;

FIG. 3 is a cross-section view of the soap bar according to lines B-B indicated in FIG. 1.

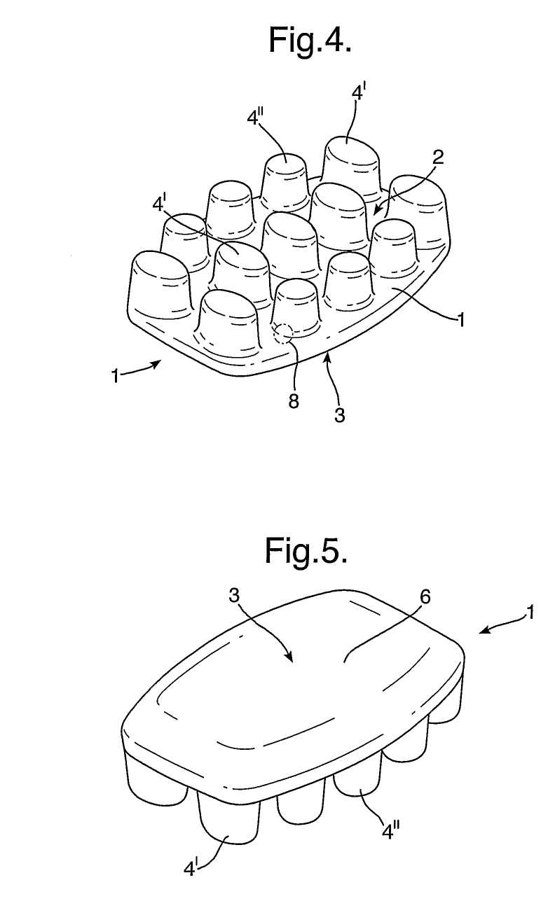

FIG. 4 is a perspective view of the massaging surface of the soap bar, according to a particular embodiment of the present invention; and

FIG. 5 is a perspective view of the grip surface of the soap bar illustrated in FIG. 4.

According to the figures, the soap bar of the present invention consists of a main body (1) having a grip body (3) and a series of projections (4) associated with it.

Originating from the inner surface (2) of the grip body (3) is a series of projections (4) distributed therein in quantity adequate to the size and dimensions of the soap bar, and also according to the dimensions and shapes of the projections (4). Particularly, the surface (2) comprises 10 to 20 projections, more particularly consisting of 13 projections (4) as in this specific example.

The grip portion (3), illustrated in FIGS. 2 and 3, comprises in its outer surface opposite to the inner surface (2) a central area whose surface is substantially rectangular, and plane (6) and that extends outwards and downwards in a smooth curve (7) so as to form a soap bar that is esthetically pleasant and ergonomically adequate for the user to hold and handle firmly.

The sum of the surface areas of the top of the projections (4) is about 20% of said inner surface area (2) (which, as previously defined, is the total area seen from a plan view, as in FIG. 1). The projections (4) have slightly round edges (5) that promote during use an efficient and comfortable feeling of massage to users.

In this example, the projections (4) are arranged by combining projections with elliptical cross-section (4′ with projections having circular cross-section (4″) wherein the body of all the projections is slightly cut-cone, i.e. with the base diameter greater than the top diameter. In this particular embodiment, the projections of the inner surface (2) central region have an elliptical cross-section (4′).

Regarding the base of the projections (4), with respect to the region of the union (8) with the lateral walls, the regions (8) are shaped to avoid sharp angles with respect to the inner surface of the grip body (3), illustrated herein with a round format. This aspect is meant to eliminate water accumulation on the inner surface (2), promoting increased durability, both of the grip body (3) and projections (4). In addition, these round regions promote increased resistance of the projections (4) against undesirable breakage when the soap bar falls on the floor or other impacts, thus its resistance is increased.

FIG. 1 shows a plan view of the inner surface (2) of the grip body (3) of the soap bar of the invention. The arrangement consists of 13 projections (4) being that 6 are circular (4″) and arranged on the upper and lower edge of the surface (2), and 7 are elliptical (4′) and arranged on the central part and laterals of the surface (2).

The projections (4) are designed to last a long period near the grip body, and to promote an efficient and pleasant massage to users.

FIG. 3 illustrates the substantially plane surface of the top of the projections (4) that promotes an efficient massage as well as uniform wear of the projections.

Specifically, the projections have a height representing about 48% of soap bar's total height. In an example of an embodiment, the projections have a height between 11.5 mm and 13.5 mm. These ratios guarantee the use of the massaging surface (2) for a longer time in comparison with prior art soaps, i.e. the soap bar will only become smooth and conventional at the end of its service life.

With reference to FIGS. 1, 2 and 3, there is illustrated a ratio of approximately 1:1 between the average diameter of the projections (4) and their height, i.e. these projections have diameters practically equal to the height. In other embodiments of the present invention, this ratio may be 2:1 (the average diameter being double the height), or still 3:1 (the average diameter being three times the height), all depending on the surface area (2) of the grip body (3), and on the projection's arrangement on the surface.

In addition to the above mentioned advantages, in this particular embodiment of the present invention described above, the soap bar of the present invention saves material since with such ratios it is possible to reduce the weight of the soap bar by about 15% in relation to prior art massage soaps, thus prolonging the massaging effects provided by the projections, which are practically maintained throughout the entire useful life of the soap as a whole.

FIGS. 4 and 5 show a particular and advantageous embodiment of the present invention, wherein the soap bar consists of a main body (1) weighing about 125 g, comprising a grip body (3) with inner surface (2) and an opposite outer surface comprising a central portion (6) with a substantially rectangular and plane surface that extends outwards and downwards by means of a relatively curved surface (7). The surface (2) has 13 cut-cone projections with base diameter greater than the top diameter, arranged in a set of circular sectioned projections (4″) and 7 elliptical sectioned projections (4″), each weighing approximately 2.5 g. The walls of the projections arranged along the edge of the surface (2) form an angle of 5° with respect to its longitudinal axis, directed toward the center of the bar.

Additionally, in the particular embodiment of the present invention, about 20% of the massaging surface (2) is substantially plane, and the region of the union (8) between the base of the projections (4) and the surface (2) has a round shape. In addition, the projections (4) have a height of about 13.5 mm, representing about 48% of the total height of the soap bar (about 28 mm).

### EXAMPLE

The following example is given for didactic proposes of a particular embodiment of the invention without imposing any limitation beyond those contained in the attached claims.

A group of consumers have tested an article according to the invention, described below, and have given their opinion about the article as mentioned below.

Product of test; a soap bar comprising a grip body with an outer and inner surface, the inner surface comprising 13 projections distributed as illustrated in the attached figures, with the following characteristics:
total area of the top surfaces of said projections: about 20% of the total area of the inner surface of the grip body;
weight of each projection: about 1.66 to 2.5 grams;
total weight of the article: about 95 grams;
region where the projection's walls contacts the inner surface of the grip body: rounded;
projections placed near the borders of the article, forming an angle toward the center of the article: about 5°;
height of the projections: about 13.5 mm;
total thickness of the article: about 28 mm;
projection shape; substantially truncated cones from their base up to their top;
6 projections having a substantially circular cross-section;
7 projections having substantially elliptical cross-section;
outer surface of the grip body with a central area generically rectangular and plane, prolonging downwards and outwards in a smooth curve;

The opinion of the great majority of consumers was as following (between 72% and 96% depending on the item). Consumers agreed that the product (the opinions set forth below are in first person, according to the given answers):
gives the skin more elasticity;
helps to improve skin firmness;
is the first step to give firmness to my skin;
helps to improve skin elasticity;
is a massage bar for firmness;
is the most pleasant way to begin the firmness care of my skin;
gives a complete firmness sensation;
is a product the massages my body;
stimulates the blood circulation.

With the aid of the teachings contained in the text and descriptions of the above example, those skilled in the art will know how to use many variations of the object of the invention, which is a plasticized article for treating the skin. Its particular characteristics can be obtained with equivalent aspects, obtaining the effects, advantages, functions and results mentioned herein, like efficiency, durability, stability and long-lasting use of said article, without deviating from the scope of protection promoted by the attached claims.

1. A plasticized article for treating the skin, including a soap bar comprising a grip body with an outer surface and an inner surface, the inner surface having one or more projections distributed along its area, characterized in that the weight of the one or more projections is between about 28% and about 70% of the total weight of the article.

2. A plasticized article for treating the skin according to claim 1, characterized in that the weight of the one or more projections is between about 28% and about 50% of the total weight of the article, more particularly 28% of the total weight of the article.

3. A plasticized article for treating the skin according to claim 1, characterized in that the weight of each projection is between about 1.5% and about 4% of the total weight of the article.

4. A plasticized article for treating the skin according to claim 1, characterized in that the total number of projections is between 1 and 50.

5. A plasticized article for treating the skin according to claim 1, characterized in that the total number of projections is between 10 and 20.

6. A plasticized article for treating the skin according to claim 1, characterized in that the total number of projections is 13.

7. A plasticized article for treating the skin according to claim 1, characterized in that at least some projections have substantially elliptical cross-section, the sum of the surface areas of the tops of the projections corresponding to about 20% of the area of the inner surface of the grip body.

8. A plasticized article for treating the skin according to claim 7, characterized in that the top surfaces of the projections are substantially plane.

9. A plasticized article for treating the skin according to claim 1, characterized in that the walls of the projections disposed on the edge of the article are adapted to promote the stability of the article when supported on the projections, forming an angle of about 5° toward the center of the article with respect to the longitudinal axis of the projection.

10. A plasticized article for treating the skin according to claim 1, characterized in that the projections are substantially truncated cones from the base to the top.

11. A plasticized article for treating the skin according to claim 1, characterized in that the perimeter of the projections is substantially free of sharp angles and points.

12. A plasticized article for treating the skin according to claim 1, characterized in that the projections have substantially elliptical or circular cross-section wherein the projections located toward the center have substantially elliptical cross-section.

13. A plasticized article for treating the skin according to claim 1, characterized in that each projection weighs between about 1.66 grams and about 2.5 grams.

14. A plasticized article for treating the skin according to claim 1, characterized in that the region where the walls of the projections meet the inner surface of the grip body are substantially free of acute angles.

15. A plasticized article for treating the skin according to claim 14, characterized in that the region where the walls of the projections meet the inner surface of the grip body are substantially round.

16. A plasticized article for treating the skin according to claim 1, characterized in that the height of the projections ranges from 40% to 50% of the total thickness of the article.

17. A plasticized article for treating the skin according to claim 1, characterized in that the height of the projections is between about 5 mm and about 20 mm.

18. A plasticized article for treating the skin according to claim 1, characterized in that the height of the projections is between about 5 mm and about 16 mm.

19. A plasticized article for treating the skin according to claim 1, characterized in that the ratio between the average diameter and the height of the projections is between about 1:1 and about 3:1.

20. A plasticized article for treating the skin according to claim 1, characterized in that the outer surface of the grip body consists of a generically rectangular and plane central area, extending outwards in a smooth curve.

21. A plasticized article for treating the skin according to claim 1, characterized in that the article weighs between about 70 grams and about 350 grams.

22. A plasticized article for treating the skin according to claim 1, characterized in that the article weighs about 95 grams.

23. A plasticized article for treating the skin according to claim 1, characterized in that one of the ingredients in the composition of the article is selected from the groups comprising soap, syndet and mixtures of both.

24. A plasticized article for treating the skin according to claim 1, characterized in that it is used with the double purpose of cleansing and massaging the skin.

25. A plasticized article for treating the skin including a soap bar consisting of a grip body with an outer and inner surface, the inner surface having one or more projections distributed along the area of the inner surface, characterized by the fact that the projections weigh about 28% of the total weight of the article, and in that each of the projections weighs between about 1.5% and about 4% of the total weight of the article, and in that the number of the projections ranges from 1 to 50, preferably 13, and in that the total surface area of the tops of the projections is about 20% of the total inner surface area of the grip body, and in that each projection weighs about 2.5 grams, and in that the total weight of the article is about 95 grams, and in that the region where the walls of the projections that meet the inner surface of the grip body is substantially round, and in that the walls of the projections located near the edges of the article form an angle directed toward the center of the article by around 5° to promote stable rest of the article when supported on said projections, and in that the height of the projections is between 11.5 mm and 13.5 mm, and in that the total thickness of the article is about 28 mm, and in that the projections are substantially truncated cones from the base to its top, and in that 6 projections have substantially circular cross-section and 7 projections have substantially elliptical cross-section, and in that the outer surface of the grip body consists of a generically rectangular and plane central area extending outwards in a smooth curve.
